(19) United States
(12) Patent Application Publication
(10) Pub. No.: US 2007/0115123 A1
(43) Pub. Date: May 24, 2007

(54) SYSTEM AND METHOD FOR ASSOCIATING BAGGAGE WITH A PASSENGER

(76) Inventors: Jon L. Roberts, Great Falls, VA (US); Elliott D. Light, Rockville, MD (US); Brian Boesch, Marlton, NJ (US)

Correspondence Address: Roberts Mardula & Wertheim, LLC, Suite 1000, 11800 Sunrise Valley Drive, Reston, VA, 20191, US

(21) Appl. No.: 11/625,931

(22) Filed: Jan. 23, 2007

Related U.S. Application Data
(63) Continuation-in-part of application No. 11/234,915, filed on Sep. 26, 2005, now Pat. No. 7,193,515.
Application No. 11/234,915 is a continuation-in-part of application No. 10/422,526, filed on Apr. 24, 2003, now Pat. No. 7,071,823.
(60) Provisional application No. 60/375,031, filed on Apr. 24, 2002.

(51) Int. Cl. G08B 13/14

(52) U.S. Cl. 340/568.1

(57) ABSTRACT

A system for associating baggage with a passenger comprises a biometric reader that captures a biometric measure from a passenger, a boarding document comprising a machine-readable boarding identifier, and a baggage tag comprising a machine-readable baggage identifier. An association processor associates the machine-readable boarding identifier and the machine-readable baggage identifier and the biometric measure.

### CROSS REFERENCE TO RELATED APPLICATION

This application is a continuation in part of U.S. application Ser. No. 11/234,915, filed Sep. 26, 2005, which is a continuation in part of U.S. application Ser. No. 10/422,526, filed Apr 24, 2003, now U.S. Pat. No. 7,071,823 issued Jul. 4, 2006, which application claims priority from U.S. provisional patent application Ser. No. 60/375,031, filed Apr. 24, 2002. The 11/234,915, 10/422,526 applications and the 60/375,031 application are incorporated herein by reference in their entirety for all purposes.

### DESCRIPTION OF THE FIGURES

FIG. 1 illustrates a block diagram of a central baggage screening facility according to an embodiment.

FIG. 2 illustrates an embodiment comprising a central screening location.

FIG. 3 illustrates a baggage screening station using RFID tags to associate a passenger with baggage according to an embodiment.

FIG. 4 illustrates an architecture of a central screening location comprising a rules engine according to an embodiment.

FIG. 5 illustrates a boarding document issuing process that utilizes RFID tags according to an embodiment.

FIG. 6 illustrates a baggage screening station using machine-readable identifiers and biometric measures for screening passengers and baggage according to an embodiment.

### DETAILED DESCRIPTION

Embodiments of a system and method for centralized inspection and evaluation of baggage are described herein. As used herein, the term “baggage” encompasses packages, backpacks, purses, luggage, and other types of containers

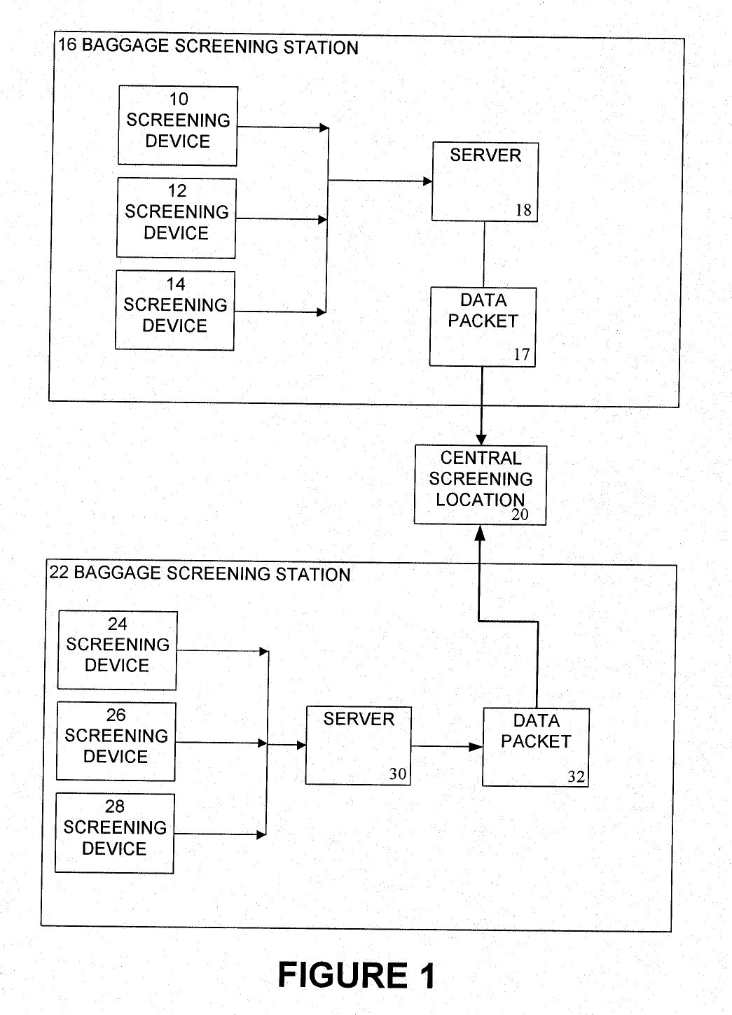

Referring to FIG. 1, an overview of the centralized baggage screening system is illustrated, Baggage screening station 16 comprises baggage screening devices 10, 12, 14. This equipment may be x-ray equipment, electronic beam equipment, chemical sniffing equipment, or any type of inspection equipment currently used or projected to be used for inspecting packages in the future. Images and data recorded from these screening devices 10, 12, 14, are sent to local server 18. Local server 18 provides identification information noting such things as time an image was taken, location, screening equipment, and other information that identifies the location from which the actual data is being received. Server 18 packages this information into a data packet 17 and conveys that data packet to a central screening location 20, as more fully set forth below. Such data is collectively referred to as “screening data.”

Similarly, another transportation facility comprises baggage screening station, 22 comprising baggage screening devices 24, 26, 28 which provide time tagged, and identified images and data to server 30. Server 30 then in turn creates its own packetized screening data 32 before shipment to central screening location 20.

By way of illustration and not as a limitation, the transportation facilities may be airports, train stations, bus stations, and subway stations. As will be appreciated by those skilled in the art, the central screening location may review screening data from all of these facilities simultaneously.

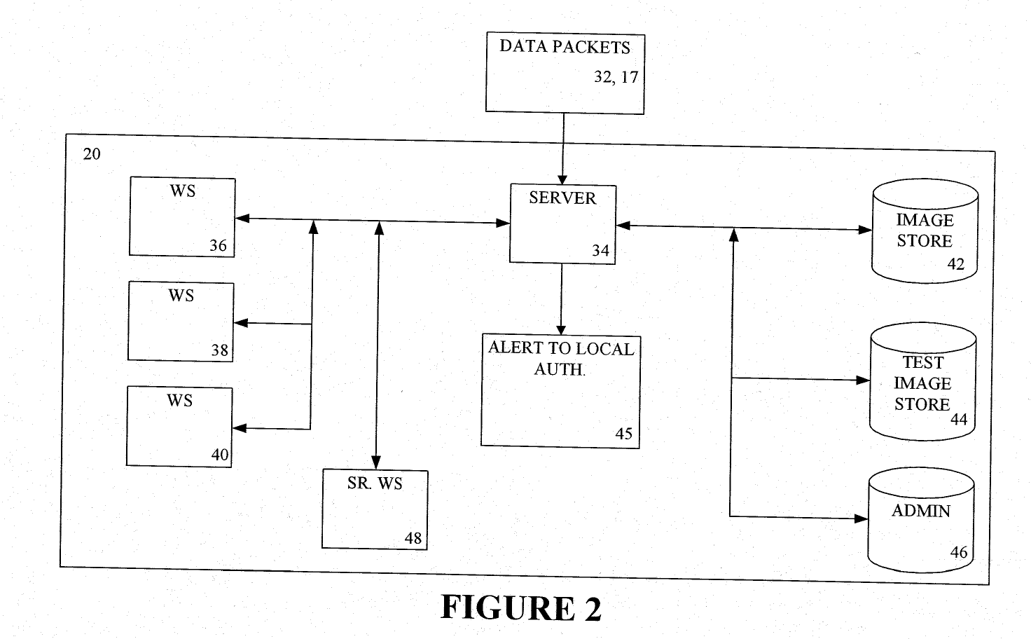

Referring to FIG. 2, the central screening location is illustrated. Screening data packets 32, 17 are received by server 34 and placed in a queue. An inspector at workstation 36 picks the next data packet in the queue for inspection. Similarly, workstations 38 and 40 select images from the data packets in a queue via server 34.

Inspectors at the various work stations 36, 38, 40 then inspect the images presented to them making judgments whether or not to “okay” the baggage in question and therefore pass that particular bag on to the passenger or to send a signal to “hand examine” or to sequester the baggage in question.

Inspectors at the various workstations 36, 38, and 40 can also assign a risk level to their inspection results with a low risk or high risk, or points in between being associated with the image (on any risk scale known in the art). Based upon the workload and the risk assessment number associated with the image, the baggage in question can then be passed to the passenger or held for subsequent inspection.

When an inspector notes an item of a particular threat, such information can be provided through server 34 to local authorities as an alert 45 so that other security action can be taken to detain the baggage and the passenger involved.

It is also possible for inspectors at workstations 36, 38, and 40 to ask for a higher level of review of an image in question. Where this occurs, the image in question is passed to a “senior” workstation 48 for subsequent review by a more senior experienced inspector. That inspector has the same options available to inspectors stationed at work stations 36, 38, and 40. That is, to assign a risk factor to the image, to detain the baggage, to provide an alert to local authorities and all other options available to other inspectors.

The central screening location 20 also comprises an image store 42 where all images for given periods of time are stored in the event that subsequent review and quality control is necessary. These images in image store 42 can be called up for review by appropriate authorities.

The central screening location 20 also comprises a test image store 44 whereby images having known items of interest or threat can be provided into the queue of server 34 for subsequent inspection by the various inspection stations 36, 38, and 40. In this fashion an inspector at any one of the workstations will receive a test image that the inspector does not know is in fact a test image. Thereafter the inspector's report can be made and quality of the inspector's work can be assessed.

The central screening location 20 also comprises an administrative store 46 wherein test results, identification of various administrative items such as identification of inspectors, their locations, the stations being screened, and a variety of other administrative data is kept.

Server 34 also comprises various artificial intelligence types of tools. Such tools can recognize shapes, textures, and specifics of images that would automatically raise a flag. Server 34 can thus pre-process the data packets 32, 17 to view this type of information.

It is also important to note that various baggage screening stations may comprise not only images of the contents of baggage but may also contain data such as from explosive sniffers. Further, inspection of baggage may be accomplished by infrared, x-ray, electron beam, and other types of sensors known in the art. Optionally, these images may be combined into a composite image that can then be presented as a data packet to the various inspection workstations 36, 38, and 40. Therefore inspectors at various workstations can receive enhanced images that are actually the composite of multiple data sources that are associated with the baggage inspection process.

In operation, x-rays, explosive “sniffers” or other type of inspection is executed. A processor at the inspection station detects the edges of baggage and separates the scans of each individual bag. Each image is then converted into a gray scale or other representation. Thereafter, the image is compressed to save data transmission time, and other data is associated with the image. For example, the inspection station number, the time of day, the bag ID at a minimum are all associated with a particular image before transmission. Other data that could be associated include (but are not limited to) photograph and ID of the bag's owner, flight information, impressions of the remaining physical inspectors about the owner. The compressed data is then transmitted to a central facility for inspection.

At the central screening location 20, the data is placed into a queue. A pool of trained screeners pick data packets from the queue and review the individual images/data and respond with a range of responses. For example, the response may be and “ok” or “pass” on the particular bag. Thereafter the traveler can be sent on his way with the examined bag. A message could be sent to “hand examine” the particular bag. Whenever a hand examine message is sent, a risk factor is associated with the bag. For example, but without limitation, 1 being the lowest risk and 9 being the highest risk. Other types of rankings may also be used. Therefore in times of high traffic volume, a risk assessment can be made and low risk items can be “passed” without hand examination if that judgment call is made.

In addition, an alert in association with a definite threat or weapon can also be sent by the central facility to the screening station, to airport security, and also to regional security for a particular area, In this fashion a large-scale alert may be sent when a definite alert has been located by the operators.

At the baggage inspection stations, local operators operate on the response from the central screening location to either pass a bag, inspect a bag, or detain the bag and the traveler.

At the central screening location a hierarchy of review takes place. At the first tier level would be the lowest skilled operator. Such operators would categorize simple cases which are obviously safe or obviously hostile. In the event that the first tier operator cannot make a decision, more complex cases are sent onto a second tier review. At the second tier review, more skilled operators who are potentially higher paid, review the images. Such second tier operators are better able to understand the imaging process and deal with the potential electronic enhancements that may be available at their workstations. Finally a third tier of operators who are highly skilled handle the most complex evaluation situation. Note that there is no fundamental limit to the tiers of evaluation. One, two, three or more tiers could be utilized depending on need. This tiered approach, in addition to allowing less skilled human evaluators to perform triage, separating obviously innocuous or dangerous bags and only passing those needing further review to higher tiers, enables the introduction of less than perfect automated or heuristic evaluation tiers. While in conventional scanning an automated system that could only unambiguously clear 10 percent of bags would be nearly useless, in this system as an early screening level, it could reduce manpower needs by roughly 10 percent.

As a result of the review at the central screening location various recommendations noted above can be made.

An analysis of bandwidth and communication needed to implement this system shows that it is quite feasible. At the present time the scanning or evaluation of a bag is approximately 5-10 seconds and includes the bags transit time through an inspection machine, operator evaluation time, and transit time to a pick up area where the bag is picked up by the passenger, thus we have a time budget of at least 5 seconds to perform data compression, transmission, evaluation and response. X-ray images of approximately 1200 by 1200 pixels can be compressed substantially yielding image sizes of between 100,000 and 1,000,000 bits. This amount of data could be transmitted over a DSL link in 0.1-5 seconds or a DS-2 data link in less than 0.05 seconds. Thus it is feasible for a small airport with only a few stations to inexpensively transmit the required screening data, while large airports could easily transmit the volume of screening data generated.

Once the screening data arrives at the central screening location, it is placed into a queue. According to an embodiment, this queue is implemented using a high-speed scalable database system or systems. From this database, evaluators (both human and automated) will select the “next” work item to evaluate. A high-speed workstation can quickly display the images/data and allow the operator to make his/her assessment, then continue on to the next bag. Historical records (kept for a predetermined amount of time) would be made of the decision and of the underlying images/data for later analysis if necessary.

Optionally, an evaluator may assign risks to the person or bag. These risks could be further evaluated even after the person has left the inspection station. Thus it is possible that a more judicious review of a particular bag may result in an alarm even after the person has entered the secure area. While clearly it is the intent to catch attackers at the stations, the ability to re-evaluate bags already in the security area may provide ways to catch or thwart attacks in progress.

Training/evaluation of operators could be easily accomplished in this system by simply adding canned “threat” images/data to the data queue to be processed by that operator. Thus an operator could receive up to several test bags per day, (rather than less than monthly in today's environment). This frequency of test data will encourage operators to be alert and provide quick detection of operators who are unable to perform. Since the workflow is completely computerized, a totally novice operator could be placed at a station and given on-the-job training by running a typical daily workload of historically collected data interspersed with test threat data. The system could prompt the operator and point out the threats in the training data through on-screen display initially and then only if there is a mistake made later. Allowing training to take place on the actual equipment in the actual environment will further decrease cost and increase the effectiveness of training.

Evaluators could also be backed up by other evaluators. Thus, an evaluator's results could be compared with results of a separate evaluator who is given the same data. This process could be used for periods of extreme threat, or simply to compare effectiveness and consistency of training.

Individual operators would be given ID's, thus when they “log on” to a workstation, they will be given work that is appropriate to them regardless of which station they use. Thus from the same station, a trainee would get training data, a level 1 evaluator would get appropriate data and a higher level expert evaluator would get only data that would require the most expert analysis.

While discussions have focused on a central screening location, it is possible that there are multiple evaluation centers that either operate independently or preferentially, operate in conjunction, sharing evaluation data through access to each others databases as well as potentially sharing data to be evaluated to balance load.

In another embodiment, the local baggage screening station is equipped to profile the baggage owner and to assign a risk factor (for any reason) or a non-risk factor. This data could be used to augment the data already passed with the baggage to enhance the evaluation of the bags data.

In still another embodiment, the association of a passenger with an item of baggage is accomplished by applying RFID tags comprising RFID identifiers to the passenger's boarding document, checked baggage and carry-on baggage. The RFID identifiers are associated with the passenger thereby tying the passenger to specific items of baggage.

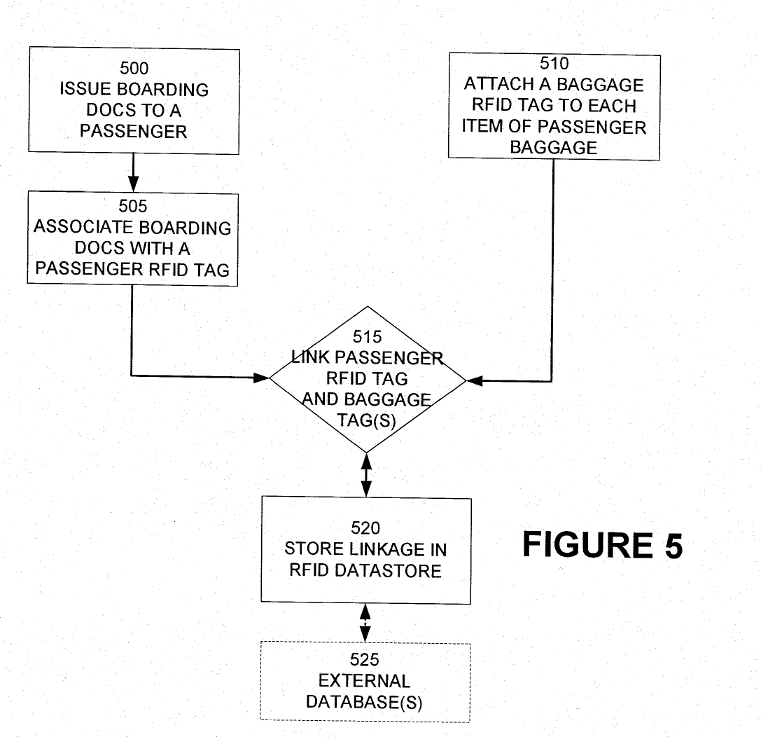

FIG. 5 illustrates a boarding document issuing process that utilizes RFID tags according to an embodiment. A passenger is issued boarding documents 500. The boarding document is associated with a passenger RFID tag 505. A baggage RFID tag is physically attached to each item of baggage of the passenger 510. In an embodiment of the invention, baggage RFID tags are issued for both carry-on and checked baggage. The passenger RFID tag and the baggage RFID tag(s) of the passenger are linked 515 and stored in an RFID datastore 520. Optionally, the datastore acquires passenger information from external databases 525 and shares information with the external databases 525. By way of illustration and not as a limitation, the external databases may be no-fly databases, customs database, immigration database, and crime databases. In another embodiment, the passenger RFID tag and the baggage tag(s) are linked to a passport identifier.

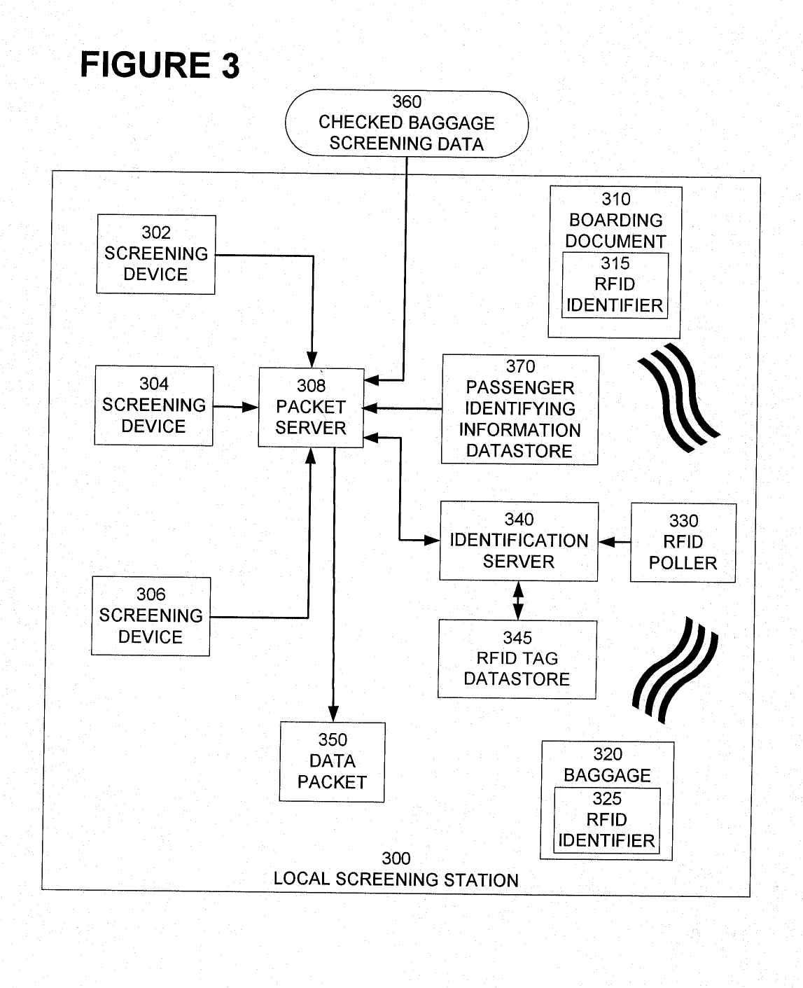

FIG. 3 illustrates a baggage screening station using RFID tags to associate a passenger with baggage.

Referring to FIG. 3, a baggage screening station 300 comprises screening devices 302, 304, and 306. Screening data acquired by screening devices 302, 304, and 306 is sent to packet server 308. Baggage screening station 300 further comprises RFID poller 330, identification server 340 and RFID tag datastore 345. In this embodiment, boarding document 310 comprises an RFID tag having an RFID identifier 315. Similarly, baggage 320 comprises an RFID tag having an RFID identifier 325. The RFID poller periodically polls baggage screening station 300 for the RFID identifiers 315 and 325 associated with boarding document 310 and baggage 320 respectively.

When the RFID identifiers 315 and 325 associated with boarding document 310 and baggage 320 are captured at a baggage screening station 300, the RFID identifiers are provided to an RFID identification server 340. RFID identification server 340 accesses RFID tag datastore 345 to determine whether the RFID identifier in the RFID tag on the passenger's boarding document and RFID identifier on the baggage RFID tag presented by the passenger for screening match. A mismatch between the RFID tag on the passenger's boarding document and the baggage presented by the passenger for screening will cause the baggage screening station 300 to initiate a remedial response. According to another embodiment, a remedial response may range from requesting an explanation from the passenger to detaining the passenger.

According to an alternate embodiment, the RFID data acquired from the boarding document 310 and the baggage 320 are provided to a central screening location (see FIG. 2, 20) where the specific remedial response initiated by the baggage screening station will be assessed by a rules engine operating at the central screening location.

In another embodiment, passengers may travel as a group so that a single member of the group may present all of the baggage for inspection. The group will be established at the time the boarding documents are issued so that the RFID identifiers of the members of the group are associated with each other and with the collective baggage of the group.

Screening data is obtained for the passenger's baggage, both for checked baggage 360 and baggage scanned by screening devices 302, 304, and 306. The screening data are forwarded to the central screening location (see FIG. 2, 20) for analysis as previously described. If the screening data is indicative of the presence of a prohibited article or substance, passenger identifying information of the passenger associated with the baggage comprising the prohibited item or substance is requested by the central screening location (see FIG. 2, 20) from packet server 308, which retrieves it from passenger identifying information datastore 370. Alternatively, the passenger identifying information may be provided with the screening data.

According to an embodiment, passenger identifying information comprises a name, address, telephone number, email address, a passenger file location identifier issued by the transportation carrier, and a credit card number.

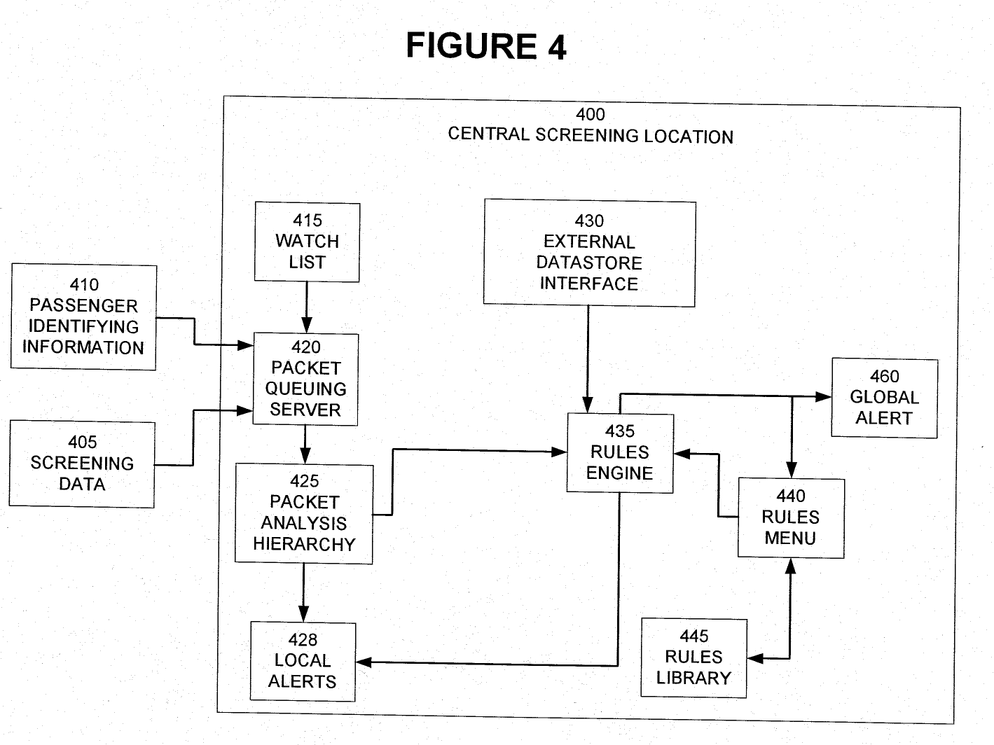

FIG. 4 illustrates an architecture of a central screening location comprising a rules engine.

Referring to FIG. 4, central screening location 400 comprises a packet queuing server 420 that receives screening data 405 and passenger identifying information 410 from baggage screening stations (see FIG. 3). Screening data 405 comprises at least data created by screening carry-on baggage and may also include screening data acquired by screening checked baggage. The packet queuing server 420 routes packets to a packet analysis hierarchy 425 as previously described. In an embodiment, the central screening location 400 maintains a watch-list 415 comprising passenger identifying information. In this embodiment, screening data and passenger identifying information are received together. Screening data 405 is treated specially by packet queuing server 420 for a passenger found to be on the watch list. Optionally, the passenger is subject to a higher level of scrutiny than a passenger who is not on the watch-list. In another embodiment of invention, the passenger is identified as a trusted person who is permitted to travel with otherwise prohibited items and substances.

The results of the packet hierarchical analysis 425 are used to issue local alerts 428 and are routed to a rules engine 435 to assess the risk posed by the identification of a prohibited item or substance in a passenger's baggage. Rules engine 435 also receives data from external datastores through external datastore interface 430. For example, passenger identifying information may be cross-checked with existing datastores to determine if factors exist in the passenger's historical data that when interpreted in light of the screening data are indicative of a threat to the transportation system. Passenger identifying information may also be cross-checked with existing datastores to obtain identifying information of associates of the passenger (individually, “associate identifying information”). Associate identifying information is then cross-checked with other passenger identifying information to determine if an associate of the passenger is traveling. If the associate is traveling, a determination is made as to the associate's place of origin, the associate's destination, and if the baggage of the associate was found to include a prohibited item or substance.

Rules engine 435 applies rules selected from a rules library 445 in accordance with rules menu 440. Rules menu 440 may be affected by the results of the application of a rule by rules engine 435. In this way, rules engine 435 is self-adjusting to a perceived security threat. Rules menu 440 may also be controlled by user input (not illustrated). Following the application of the rules menu 440, rules engine may issue a global alert 460 or revise a local alert 428.

As previously described, the transportation facilities may be airports, train stations, bus stations, and subway stations. Optionally, the central screening location may review screening data from all of these facilities simultaneously.

The rules library 445 comprises security rules that are created or received by the central screening location 400. Security rules may be specific to a type of transportation facility, the size of the transportation facility, the location of the transportation facility, and to a variable security alert level established by the central screening location or a government agency having control of the central screening location.

Security rules may also be applied in stages. By way of illustration and not as a limitation, a first security rule is applied to an article of baggage (checked and carry-on) to determine whether the screening data for that article indicate that an “alert” should be issued for the article and, if so, the nature of the alert. A second security rule is applied to all screening data generated by a transportation facility on a continuous basis. A third rule is applied to all screening data generated by all transportation facilities within a geographic area. A fourth rule is applied to all screening data acquired world-wide. This staged application of security rules may be directed by user input or applied automatically by the rules menu 440 in response to direction from the rules engine 435.

As will be appreciated by those skilled in the art, the application of the various security rules may be preceded by data filters that reduce the volume of screening data to be processed by the rules engine. By way of illustration and not as a limitation, data filters may be applied at any stage to eliminate screening data by date, location, and content. Thus, a hierarchy of security rules may be established whereby only screening data reflecting that an item of baggage contains a prohibited or suspicious article is further evaluated.

In yet another embodiment, a passenger is associated with an item of baggage and the security engine operates on passenger data as well as screening data. In this embodiment, the passenger is associated not only with checked baggage but with carry-on baggage as well. This association of a passenger and baggage may be accomplished, for example, using RFID tags as previously described. As will be appreciated by those skilled in the art, the reference to RFID tags is exemplary and not limiting. Other means may be used for associating an object with an object owner. By way of illustration and not as a limitation, an object and an object owner may be associated using graphical codes (i.e. bar, 2-D, 3-D codes) and encoded magnetic field devices.

In another embodiment, a passenger is associated with baggage using a boarding document and a biometric identifier.

In this embodiment, a passenger presents or purchases a ticket at a check-in station. The passenger is provided a boarding document comprising a machine-readable boarding identifier. A baggage tag comprising a machine-readable luggage identifier is affixed to the passenger's baggage (i.e., carry-on or checked bags). By way of illustration, the machine-readable readable boarding identifier and machine-readable baggage identifier may be RFID tags, graphical codes (i.e. bar, 2-D, 3-D codes) and encoded magnetic field devices.

A biometric reader captures a biometric measure from the passenger. Optionally, the biometric measure may be saved as an image file or digitally encoded and saved in a digital form. By way of illustration and not as a limitation, a “biometric measure” measures and analyzes human physical and behavioral characteristics for authentication purposes, Examples of physical characteristics include fingerprints, eye retinas and irises, facial patterns and hand measurements, and infrared measurements, while examples of mostly behavioral characteristics include signature, gait and typing patterns. Voice is considered a mix of both physical and behavioral characteristics. Other biometrics, whether based on physical characteristics, behavioral characteristics, or mixture of both physical and behavioral characteristics, may also be used.

An association processor associates the machine-readable boarding identifier, the machine-readable baggage identifier and the biometric measure. Optionally, the biometric measure may be forwarded to a central screening facility for both authentication processing and security processing. With respect to authentication processing, the biometric information (either alone or together with other information) may be compared to data held in various repositories, including, without limitation, criminal databases, driver's license databases, passport databases, military databases and government employee databases. With respect to security processing, the biometric information may be compared to data held in databases maintained by security agencies to determine if the passenger is a security risk.

In an embodiment, the biometric measure is stored in a database in association with the machine-readable boarding identifier and the machine-readable baggage identifier. In another embodiment, the biometric measure is encoded into the machine readable boarding identifier and/or the machine readable baggage identifier. In still another embodiment, the biometric measure is encoded on the boarding document and/or the baggage tag separate from other identifiers.

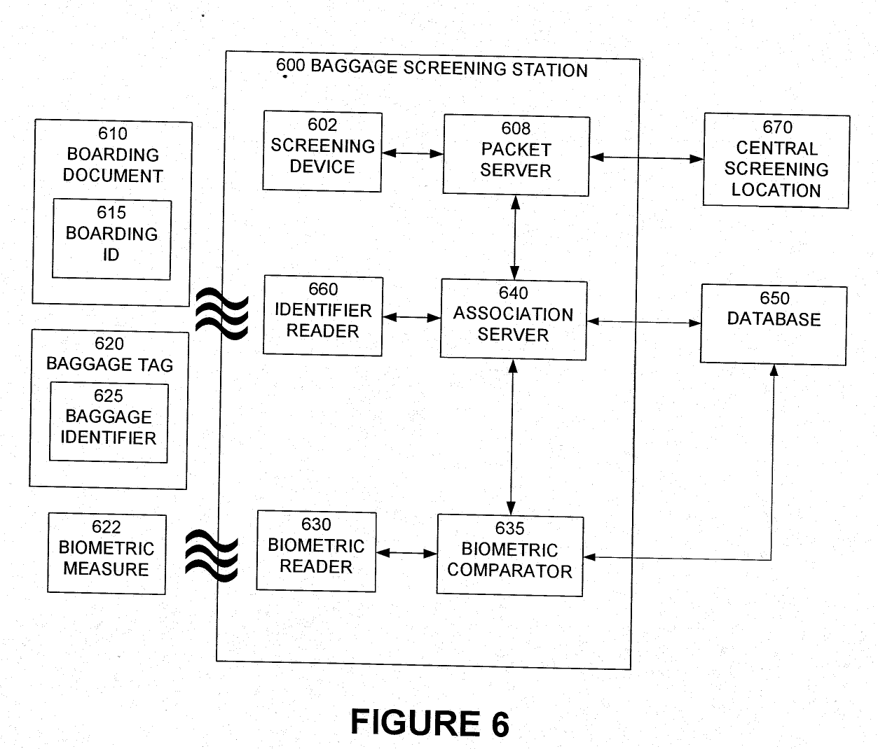

FIG. 6 illustrates a baggage screening station using machine-readable identifiers and biometric measures for screening passengers and baggage according to an embodiment.

Referring to FIG. 6, a baggage screening station 600 comprises screening device 602. Screening data acquired by screening device 602 is sent to packet server 608 for communication to a central screening station 670. Baggage screening station 600 further comprises identifier reader 660 (for reading boarding identifiers and baggage identifiers), biometric reader 630, biometric comparator 635, and association server 640. In this embodiment, boarding document 610 comprises a machine-readable boarding identifier 615. Similarly, baggage tag 620 comprises a machine-readable baggage identifier 625. A screening protocol is established by a screening authority (not illustrated). The screening protocol determines the degree of screening to be applied by the baggage screening station 600 to a passenger seeking entry to a secure area of a facility, such as a transportation terminal.

By way of illustration, the screening protocol may dictate that the machine-readable boarding identifier and the machine-readable baggage identifier be read by identifier reader 660 and sent to association server 640. There, association server 640 accesses data collected at check-in and stored in database 650 to confirm that the baggage tag is properly associated with the boarding document. Optionally, the protocol may require that the passenger present the exact number of bags originally associated with the boarding document to the screening station for screening.

In another embodiment, the screening protocol dictates that a biometric measure 622 of a passenger seeking entry to a secure area of a facility be read by biometric reader 630. The biometric measure read by biometric reader 630 is sent to biometric comparator 635 for comparison to biometric measure captured at check-in. Biometric comparator 635 may acquire the biometric measure captured at check-in via a network accessible to both the check-in counter and the baggage screening station, via a code added to the boarding document and/or the baggage tag, or from the boarding machine-readable code and/or the baggage machine-readable code. If the biometric measures match, the passenger may be permitted access to the secure area or the passenger may be subject to additional screening as dictated by the screening protocol. If the biometric measures do not match, the screening protocol will establish what action is to be taken regarding the passenger. By way of illustration, the passenger may be requested to provide an explanation of any discrepancies or the passenger may be detained.

Optionally, biometric measure acquired from the passenger and the machine readable identifiers acquired from the boarding document 610 and the baggage tag 620 are provided to a central screening location (see FIG. 2, 20) where the specific remedial response initiated by the baggage screening station will be assessed by a rules engine operating at the central screening location. Passenger identifying data as previously described may be used in this assessment process.

In another embodiment, the passenger is required to present a personal identifying document at the check-in counter. By way of illustration and not as a limitation, examples of personal identifying documents are financial instruments, such as credit cards, debit cards and personal check routing numbers, and drivers' licenses. Optionally, the risk of fraud can be mitigated by verifying that a financial instrument presented by the passenger is not in use, or has not been used within a specified time period and specified distance from the location of the check-in counter. In yet another embodiment, cell phone records can be checked to determine an approximate location of the person in whose name the ticket was purchased. While the use of financial instruments to mitigate fraud and improve security may raise privacy issues, the expectation of privacy with respect to the use of financial information has, to some degree, been exchanged for the convenience of using various financial instruments. Routinely, the use of debit cards is photographed and transaction data is shared with credit bureaus to create credit ratings. As will be appreciated by those skilled in the art, similar information having a limited expectation of privacy can be used to verify the personal identity of the passenger without departing from the scope hereof.

In an embodiment, the boarding document is issued through an automated check-in terminal. The terminal prompts the passenger for a ticket comprising a machine-readable ticket identifier. The ticket identifier is read by the check-in terminal and the passenger biometric measure is acquired. The boarding document is issued. A baggage tag comprising a machine-readable baggage identifier is issued by an attendant and affixed to the passenger's luggage.

In yet another embodiment, the passenger presents a boarding document, baggage associated with the passenger, and a biometric measure to a baggage screening station. The baggage screening data and the passenger identifying information are processed as previously described (see, FIG. 4 and related discussion above). In an alternate embodiment, the function of the check-in counter in issuing documents and the functions of the baggage screening station are performed in a single location.

In still another embodiment, a passenger is associated with baggage using a boarding document and a personal identifying document. In this embodiment, a biometric measure is not used. Rather, a personal identifying document is used for both authentication processing and security processing.

In yet another embodiment, a passenger may provide authenticating information in advance of using transportation facilities. The authenticating information may be confirmed in advance of travel and associated with a biometric measure. Additionally, a security profile of the passenger may be maintained in a database that is updated regularly. Optionally, the security profile of the passenger is updated in advance of a scheduled flight based on a passenger manifest provided by a transportation facility. A screening protocol may dictate that passengers that were not included on the flight manifest be subject to a higher level of screening than passengers that have been at least in part, pre-screened.

In yet another embodiment, a screening protocol may dictate that arriving passengers pass through an exit baggage screening facility to determine that all baggage associated with the passenger has been collected by the passenger. Further, baggage that has not been collected at a baggage claim can be associated with other passenger information to determine if a potential threat exists relating to the association between the unclaimed baggage and the passenger. As previously described, this determination may be accomplished using the machine readable baggage identifier, the machine readable boarding identifier, and the biometric measure, either alone or in combination.

A centralized system and method of security screening has now been described. While baggage screening has been described, packages of all types such as shopping bags, personal bag, backpacks and other types of packages may be screened as well. While airports are a significant location, other locations such as schools and public and private buildings, may also be protected. It will also be appreciated by those skilled in the art that use of RFID tags for baggage (checked and carry on) can also be used for baggage management purposes. For example, baggage throughput could easily be tracked (bags per hour handled), delay from time of landing to time of arrival at a baggage pick up location and other such statistics can easily be handled. Further, use of RFID tags can note when a passenger left a flight (i.e., at a transfer point) but the passenger's bags stayed on the flight, or vice versa. This will further prevent lost baggage and add to air travel security by noting when passengers and baggage became separated.

Other embodiments using the concepts described herein are also possible. Further, any reference to claim elements in the singular, for example, using the articles “a” “an,” or “the” is not to be construed as limiting the element to the singular. Moreover, a reference to a specific time, time interval, and instantiation of scripts or code segments is in all respects illustrative and not limiting.

What is claimed is:

1. A system for associating baggage with a passenger comprising:
a biometric reader, wherein the biometric reader is adapted for capturing a biometric measure from a passenger;
a boarding document, wherein the boarding document comprises a machine-readable boarding identifier;
a baggage tag, wherein the baggage tag comprises a machine-readable baggage identifier; and
an association processor, wherein the association processor is adapted for associating the machine-readable boarding identifier and the machine-readable baggage identifier and the biometric measure.

2. A system for system for centralized security screening comprising:
a biometric reader, wherein the biometric reader is adapted for capturing a biometric measure from a passenger;
a boarding document a boarding document, wherein the boarding document comprises a machine-readable boarding identifier;
a baggage tag, wherein the baggage tag comprises a machine-readable baggage identifier; and
an association processor, wherein the association processor is adapted for associating the machine-readable boarding identifier and the machine-readable baggage identifier and the biometric measure
a remote screening facility comprising screening devices, wherein the remote screening facility is adapted for:
reading the machine-readable baggage identifier;
reading the machine-readable boarding identifier;
capturing the biometric measure from the passenger;
screening the baggage under inspection using a screening device in accordance with a first screening procedure to obtain screening data; and
reporting screening data, the biometric measure, the machine readable boarding identifier and the machine-readable baggage identifier to a centralized screening facility; and wherein
the centralized screening facility is connected to the remote screening facility via a network, and wherein the centralized screening facility is adapted for:
receiving the screening data, the biometric measure, the machine readable boarding identifier and the machine-readable baggage identifier from the remote screening facility;
reviewing the screening data using a security protocol to determine whether the baggage under inspection represents a security risk; and
if the baggage under inspection represents a security risk, then using the identity of the baggage owner to obtain personal information about the baggage owner associated with the baggage under inspection;
applying the security protocol to the personal information and the screening data to formulate a remedial action plan with respect to the baggage under inspection; and
advising the remote screening facility of the remedial action plan.

3. A method for associating baggage with a passenger comprising:
associating a passenger with a passenger RFID tag, wherein the passenger RFID tag comprises a unique passenger identifier;
associating a baggage unit with a baggage RFID tag, wherein the baggage RFID tag comprises a unique baggage identifier;
associating a biometric measure with the passenger;
associating the unique passenger identifier with the unique baggage identifier and the biometric measure; and
storing the associated unique passenger identifier with the associated unique baggage identifier and the biometric measure in a storage device accessible via a network.

4. A method for formulating a remedial action plan with respect to an object under inspection comprising:
associating the object with an object identifier;
associating an identity of an owner of the object (herein, the “object owner”) with a biometric measure acquired from the object owner;
associating the object under inspection with the identity of the object owner using the object identifier and the biometric measure;
screening the object under inspection at a remote screening facility using a screening device in accordance with a first screening procedure to obtain screening data, the biometric measure and the object identifier;
reviewing the biometric measure and the object identifier at the remote screening facility using a first security protocol to determine whether the object under inspection is associated with the biometric measure;
if the object under inspection is associated with the biometric identifier, reviewing the screening data at a centralized screening facility using a second security protocol to determine whether the object under inspection represents a security risk;
if the object under inspection represents a security risk, then using the identity of the object owner to obtain personal information about the object owner associated with the object under inspection;
applying the second security protocol to the personal information and the screening data to formulate a remedial action plan with respect to the object under inspection; and
advising the remote screening facility of the remedial action plan.
